(19) United States
(12) Patent Application Publication
(10) Pub. No.: US 2009/0195903 A1
(43) Pub. Date: Aug. 6, 2009

(54) METHOD OF EVALUATING MAGNETORESISTIVE HEAD

(75) Inventor: Mutsuo Yoshinami, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/237,141

(22) Filed: Sep. 24, 2008

(30) Foreign Application Priority Data
Feb. 5, 2008 (JP) 2008-024622

(51) Int. Cl. G11B 27/36

(52) U.S. Cl. 360/31; G9B/27.052

(57) ABSTRACT

The method is capable of perfectly detecting unstably magnetized magnetoresistive heads. The method of evaluating a magnetoresistive head comprises the steps of: applying a magnetic field to the magnetoresistive head, in the direction parallel to an air bearing surface of the magnetoresistive head, at a prescribed temperature; obtaining an image of the air bearing surface in a first magnetized state by using the Kerr effect; applying an external stress to the magnetoresistive head; obtaining an image of the air bearing surface in a second magnetized state by using the Kerr effect; and evaluating characteristics of the magnetoresistive head on the basis of the images of the first magnetized state and the second magnetized state or by comparing the images of the first magnetized state and the second magnetized state.

### BACKGROUND OF THE INVENTION

The present invention relates to a method of evaluating a magnetoresistive head, more precisely relates to a method of evaluating a magnetoresistive head, in which characteristics are evaluated on the basis of images of an air bearing surface obtained by using the Kerr effect.

A megnetoresistive head, in which, for example, a magnetoresistance effect element, e.g., MR element, is used in a reproducing head section, has been actually used as a thin film magnetic head for reproducing data recorded on a magnetic storage medium, e.g., magnetic disk.

In the magnetoresistive head, a magnetoresistance effect of a magnetic film is used, so a great output power can be obtained without reference to a relative speed with respect to the magnetic storage medium. However, magnetic domains of shielding layers, which are magnetic layers and which sandwich the magnetoresistance effect element, are varied by external magnetic fields, and thereby bad products, in which an output power variation occurs, will be produced. Namely, bad magnetoresistive heads, in which output power variations occur, cannot normally reproducing data. Therefore, evaluation tests are performed in the production process so as to eliminate bad products.

However, the bad magnetoresistive heads, in which characteristics are varied by variation of the magnetic domains of the shielding layers (shield magnetic domains), cannot be quantitatively detected. Therefore, a suitable evaluation method has been required.

A conventional method of evaluating a magnetoresistive head comprises the steps of: applying a magnetic field to the magnetoresistive head in the direction being parallel to shielding layers and forming an angle of 0° with an air bearing surface of the magnetoresistive head (ordinary magnetization); measuring output voltage of the magnetoresistive head; repeating the above described steps; and evaluating an output power variation of the magnetoresistive head on the basis of a difference between the maximum output voltage of the magnetoresistive head and the minimum output voltage thereof.

However, in the above described conventional evaluation method, the shield magnetic domains will be easily varied, so bad magnetoresistive heads which are unstably magnetized cannot be perfectly detected.

To solve the problem, an evaluation equipment was developed (see Japanese Laid-open Patent Publication No. 10-124828). The equipment is shown in FIG. 7. The evaluation equipment comprises: an MR head 71; a sensing current supply source 72; an output voltage amplifier 73; a coil unit 74 for generating a magnetic field; a coil current amplifier 75; a waveform generator 76; a digital oscilloscope 77; and a computer 78.

Characteristics of the MR head 71 is evaluated by obliquely applying an external magnetic head with respect to an MR stripe. However, in case that MR heads are formed on a large wafer, e.g., 5-6 inch wafer, magnetizing directions of MR stripes of the MR heads formed in a center part and an outer part of the wafer will be easily uneven. Further, a magnetic domain control films will be easily uneven, so that a test of unevenness can be performed.

### SUMMARY OF THE INVENTION

The present invention was conceived to solve the problems of the conventional technology.

An object of the present invention is to provide a suitable method of evaluating a magnetoresistive head, which is capable of perfectly detecting unstably magnetized magnetic heads, which cannot be perfectly detected by the conventional methods.

To achieve the object, the present invention has following constitutions.

Namely, a method of evaluating a magnetoresistive head comprises the steps of: applying a magnetic field to the magnetoresistive head, in the direction parallel to an air bearing surface of the magnetoresistive head, at a prescribed temperature; obtaining an image of the air bearing surface in a first magnetized state by using the Kerr effect; applying an external stress to the magnetoresistive head; obtaining an image of the air bearing surface in a second magnetized state by using the Kerr effect; and evaluating characteristics of the magnetoresistive head on the basis of the images of the first magnetized state and the second magnetized state or by comparing the image of the second magnetized state with that of the first magnetized state.

With this method, stability of the magnetized state of a layer composed of a magnetic material can be evaluated, so that characteristics of the magnetoresistive head can be evaluated.

In the method, the magnetoresistive head may include shielding layers, which are formed on the upper side and the lower side of a magnetoresistance effect reproducing element, and magnetized states of the shielding layers may be evaluated in the evaluating step.

With this method, stabilities of the shielding layers can be evaluated.

Another method of evaluating a magnetoresistive head, in which shielding layers are formed on the upper side and the lower side of a magnetoresistance effect reproducing element, comprises the steps of: applying a magnetic field to the magnetoresistive head, in the direction parallel to an air bearing surface of the magnetoresistive head; obtaining an image of the air bearing surface in a first magnetized state by using the Kerr effect; applying an external stress to the magnetoresistive head; obtaining an image of the air bearing surface in a second magnetized state by using the Kerr effect; repeating the above described steps a plurality of times at a prescribed temperature; and evaluating the magnetized states of the shielding layers by comparing the obtained images of the air bearing surface in the first magnetized states or the obtained images of the air bearing surface in the second magnetized states.

With this method, by repeating the step of applying the external stress a plurality of times, the magnetoresistive head can be securely evaluated even if the magnetized state of the magnetoresistive head is varied.

Further, a method of evaluating a magnetoresistive head, in which shielding layers are formed on the upper side and the lower side of a magnetoresistance effect reproducing element, comprises the steps of: applying a magnetic field to the magnetoresistive head, in the direction parallel to an air bearing surface of the magnetoresistive head; obtaining an image of the air bearing surface in a first magnetized state by using the Kerr effect; applying an external stress to the magnetoresistive head; obtaining an image of the air bearing surface in a second magnetized state by using the Kerr effect; repeating the above described steps a plurality of times at different temperatures; and evaluating the magnetized states of the shielding layers by comparing the obtained images of the air bearing surface in the first magnetized states or the obtained images of the air bearing surface in the second magnetized states.

With this method, the magnetized state of the magnetoresistive head can be evaluated at different temperatures.

In each of the above described method, a direction of applying the magnetic field may form an angle with the air bearing surface of the magnetoresistive head in the step of applying the external stress.

With this method, the magnetized state of the magnetoresistive head can be evaluated with optionally applying the magnetic field as the external stress.

In each of the above described method, an electric current may be passed through an element of the magnetoresistive head in the step of applying the external stress.

With this method, the magnetized state of the magnetoresistive head can be evaluated with passing the electric current through the element, e.g., magnetoresistance effect reproducing element, heater element.

In each of the above described method, an electric current may be passed through a recording head section of the magnetoresistive head in the step of applying the external stress.

With this method, the magnetized state of the magnetoresistive head can be evaluated with passing the electric current through the recording head section.

### BRIEF DESCRIPTION OF THE DRAWINGS

Embodiments of the present invention will now be described by way of examples and with reference to the accompanying drawings, in which:

FIG. 1 is a schematic view of a magnetoresistive head, which will be evaluated by the evaluation method of the present invention;

FIG. 2 is an evaluation equipment for performing the evaluation method of the present invention;

FIG. 3 is a flowchart showing the steps of the evaluation method of the present invention;

FIG. 4A is an image of a magnetized shielding layer obtained by using the Kerr effect;

FIG. 4B is a schematic view of the magnetized shielding layer;

FIG. 5A is an image of another magnetized shielding layer obtained by using the Kerr effect;

FIG. 5B is a schematic view of the magnetized shielding layer;

FIGS. 6A-6H are explanation views showing evaluation examples of the magnetoresitive head; and

FIG. 7 is a schematic view of the conventional evaluation equipment.

### DETAILED DESCRIPTION OF THE EMBODIMENTS

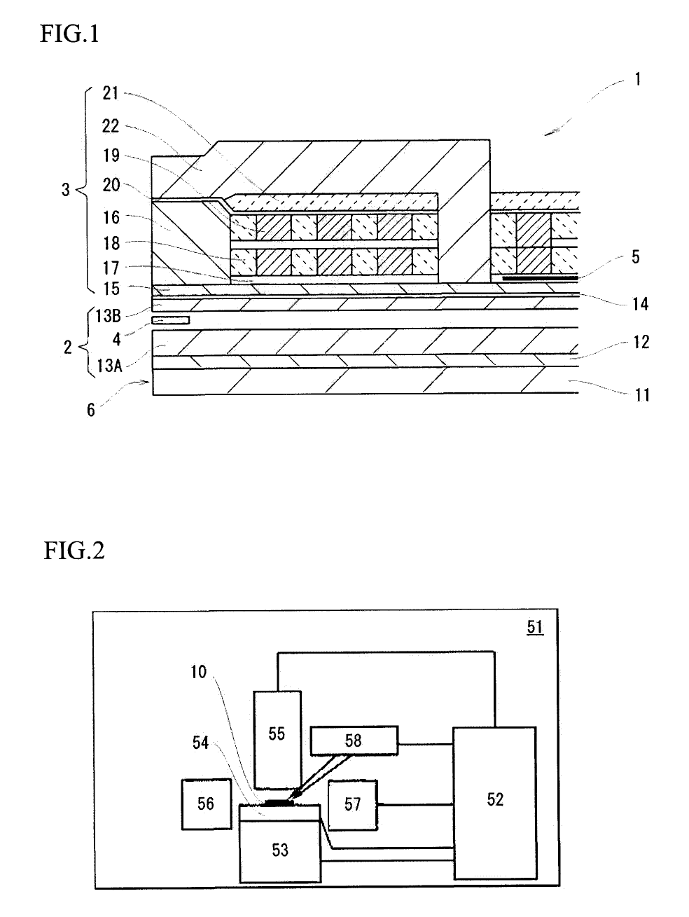

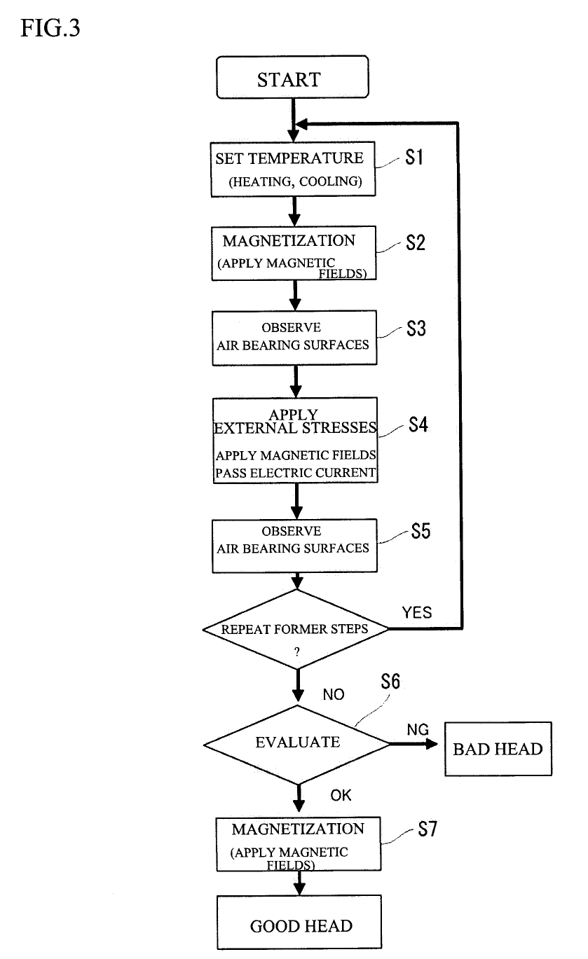

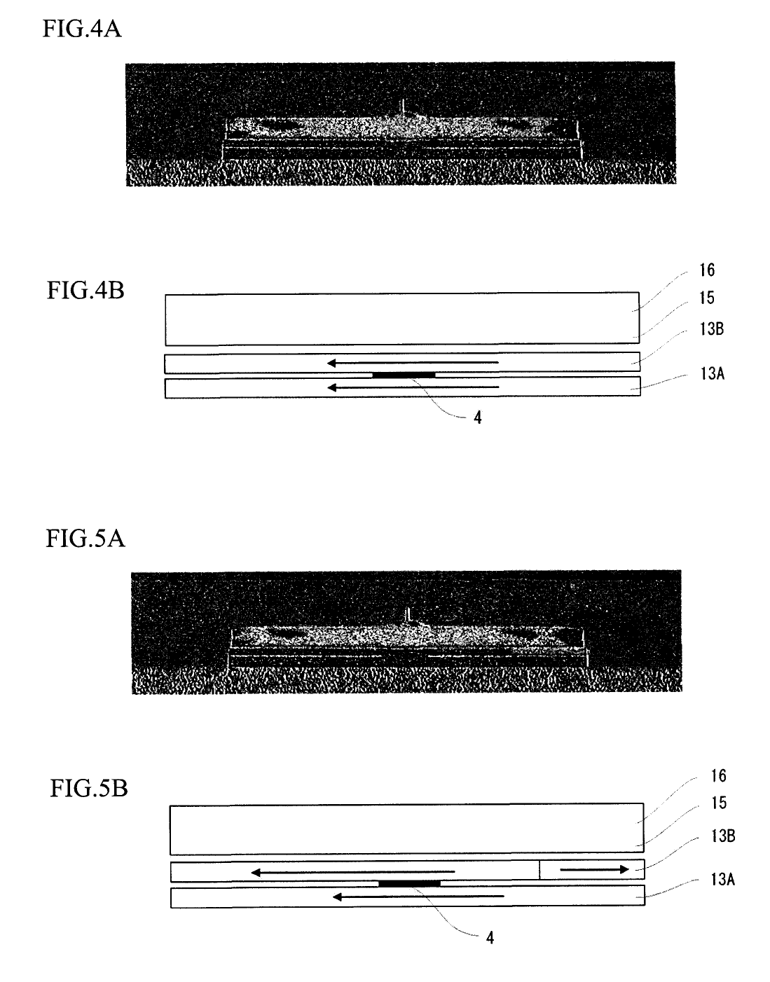

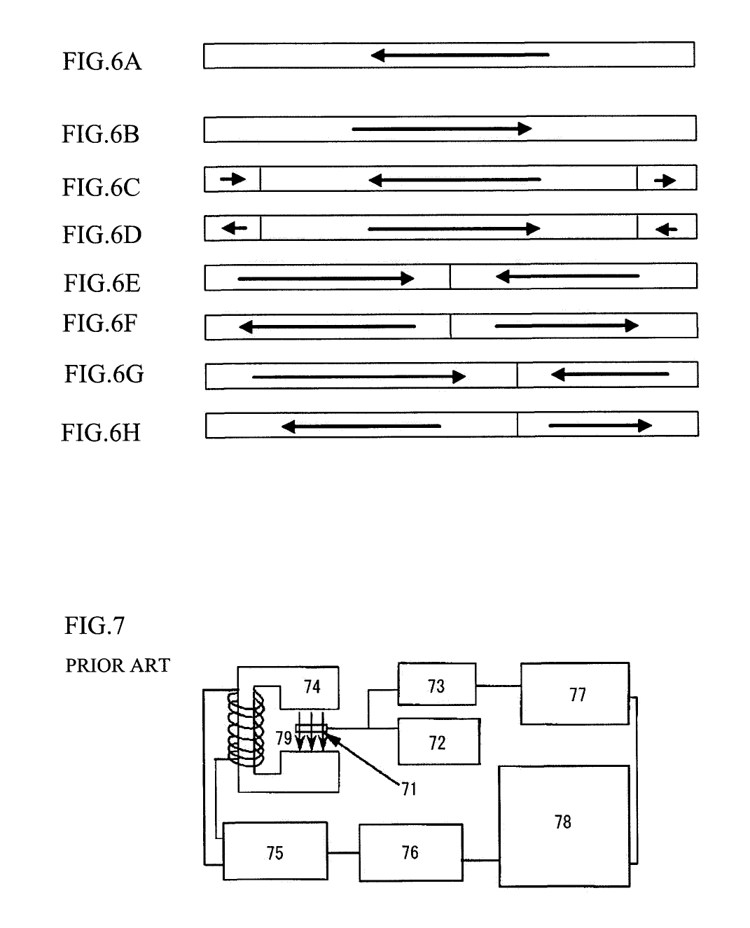

Preferred embodiments of the present invention will now be described in detail with reference to the accompanying drawings, in which: FIG. 1 is a schematic view of a magnetoresistive head 1, which will be evaluated by the evaluation method of the present invention; FIG. 2 is an evaluation equipment 51 for performing the evaluation method of the present invention; FIG. 3 is a flowchart showing the steps of the evaluation method of the present invention; FIG. 4A is an image of a magnetized shielding layer 13 obtained by using the Kerr effect (good product); FIG. 4B is a schematic view of the magnetized shielding layer (good product); FIG. 5A is an image of another magnetized shielding layer 13 obtained by using the Kerr effect (bad product); FIG. 5B is a schematic view of the magnetized shielding layer (bad product); and FIGS. 6A-6H are explanation views showing evaluation examples of the magnetoresitive head, each of which is a picture of the magnetized state of a shielding layer 13A or 13B based on the image obtained by using the Kerr effect.

Firstly, the Kerr effect will be explained. The Kerr effect is a physical phenomenon, in which a magnetic body generates magnetorotation (polarization plane rotation), etc., depending on a magnetization direction of a magnetic body, by illuminating the magnetic body. Therefore, the magnetized state of the magnetic body can be visually observed by using the Kerr effect.

Next, an example of the magnetoresistive head evaluated by the method of the present invention will be explained. Note that, the magnetoresistive head to be evaluated is not limited to this example.

As shown in FIG. 1, the magnetoresistive head 1 has a reproducing head section 2 and a recording head section 3. The reproducing head section 2 includes a magnetoresistance effect reproducing element 4, which is formed between a lower shielding layer 13A and an upper shielding layer 13B as an inner layer of a multilayer structure. A symbol 6 stands for an air bearing surface, which faces a surface of a magnetic storage medium, e.g., magnetic disk.

In the reproducing head section 2 having the multilayer structure, an undercoat film 12, the lower shielding layer 13A, the magnetoresistance effect reproducing element 4 and the upper shielding layer 13B are layered on a substrate 11. For example, the substrate 11 is composed of an insulating material, e.g., Al₂O₃-Tic. The undercoat film 12 formed on the substrate 11 is composed of an insulating material, e.g., Al₂O₃.

For example, the magnetoresistance effect reproducing element 4 may be a tunneling magnetoresistance (TMR) element or a giant magnetoresistance (GMR) element. The TMR element or the GMR element may have various types of film structures. Note that, a current perpendicular to plane-GMR (CPP-GMR) element or a current in plane-GMR (CIP-GMR) element may be employed as the GMR element.

The lower shielding layer 13A is composed of a soft magnetic material, e.g., permalloy. The upper shielding layer 13B too is composed of a soft magnetic material, e.g., permalloy. Since magnetized states of the shielding layers 13A and 13B influence characteristics of the reproducing head section 2, the magnetized states thereof must be stable to external factors, e.g., temperature, magnetic field, recording action. Especially, their magnetization directions must be same.

Note that, in case of using a TMR element or a CPP-GMR element as the magnetoresistance effect reproducing element 4, the shielding layers 13A and 13B act as electrodes of the element 4. On the other hand, in case of using a CIP-GMR element as the magnetoresistance effect reproducing element 4, the shielding layers 13A and 13B do not act as electrodes.

In the present embodiment, a magnetization separation layer 14 is formed on the upper shielding layer 13B, and the recording head section 3 is formed on the magnetization separation layer 14. A symbol 5 stands for a heating element for controlling a projection length of the head toward the air bearing surface 6.

In the recording head section 3, a lower magnetic pole 15 and a lower tip magnetic pole 16, which are composed of a magnetic material, e.g., permalloy, are formed on the magnetization separation layer 14. An insulating layer 17 is formed on the lower magnetic pole 15. The insulating layer 17 is composed of an insulating material, e.g., Al₂O₃.

Electrically conductive coils 19 are formed on the insulating layer 17 with a prescribed separation. The coils 19 are composed of an electrically conductive material with low resistance, e.g., copper, and have planar spiral configurations. Insulating layers 18 are respectively formed in spaces defined by coil wires of the coils 19. The insulating layers 18 are composed of an insulating material, e.g., Al₂O₃.

A gap layer 20 is formed on the upper coil 19, the upper insulating layers 18 and the lower tip magnetic pole 16. The gap layer 20 is composed of an insulating material, e.g., SiO₂.

An insulating layer 21 is formed on the gap layer 20. The insulating layer 21 is composed of an insulating material. Further, an upper magnetic pole 22 is formed on the gap layer 20 and the insulating layer 21. The upper magnetic pole 22 is composed of a magnetic material, e.g., permalloy. Note that, the upper shielding layer 13B and the lower magnetic pole 15 may be formed as one layer. In this case, the magnetization separation layer 14 is omitted.

Next, an evaluation equipment for performing the method of the present embodiment will be explained.

In FIG. 2, a test head 10 is formed into a raw bar, in which a plurality of the magnetoresistive heads 1 are aligned in the longitudinal direction. The test head 10 is mounted on a table 54, which is provided on a rotatable X-Y-Z-θ stage 53. The table 54 is capable of heating, cooling the test head 10 and measuring temperature of the test head 10.

A Kerr effect unit 55 is used to observe magnetized states of magnetic layers in the test head 10. In the present embodiment, the Kerr effect unit 55 is connected to a control unit 52 so as to obtain images of the magnetized states, process the obtained images and evaluate the magnetoresistive heads 1 on the basis of the processed data.

Magnetic field generation coil units 56 and 57 apply external a magnetic field to the test head 10 as external a stress. An electric source unit 58 passes an electric current through the test head 10 as an external stress. The coil units 56 and 57 and the source unit 58 are controlled by the control unit 52.

Next, the evaluation method of the present embodiment will be explained with reference to a flowchart of FIG. 3.

Firstly, the test head 10 is mounted on the table 54, which has been placed between the coil units 56 and 57, and then a preparatory work for the evaluation is performed.

A temperature of the test head 10 is maintained at a prescribed temperature by using the heating or cooling function of the table 54 (step S1). The temperature of the test head 10 may be selected, for example, from −50° C. to 100° C.

Next, the coil units 56 and 57 apply prescribed magnetic fields to the test head 10 (step S2). At that time, the directions of the magnetic fields are parallel to surfaces of the shielding layers 13A and 13B of the test head 10 and the air bearing surface 6.

Next, the magnetized states of the magnetic layers of the test head 10 are observed by the Kerr effect unit 55 (step S3). In the present embodiment, the control unit 52 retrieves data of the magnetized states as images, and then processes the images for evaluating characteristics.

Next, the external stresses are applied to the test head 10 (step S4). For example, the coil units 56 and 57 apply external magnetic fields, whose directions form angles θ (0°≦θ<360°) with the air bearing surfaces 6 of the test head 10 by rotating the X-Y-Z-θ stage 53, or the source unit 58 passes an electric current through the recording head sections 3, the magnetoresistance effect reproducing elements 4 or the heating elements 5 of the test head 10. Further, the above described two manners may be combined.

Note that, the manner of applying external stress or stresses is not limited to the above described examples.

In the present embodiment, the magnetic fields, which are applied as the external stresses, are applied in the direction parallel to the surfaces of the shielding layers 13 of the test head 10. Intensity of the magnetic fields is, for example, 5 KOe or less.

After applying the external stresses, the magnetized states of the magnetic layers of the test head 10 are observed by the Kerr effect unit 55 (step S5) as well as the step 3.

If the magnetized state of the magnetoresistive head 1, which has been observed in the step S1 or S5, is different from a predefined normal state, or if the magnetized state of the magnetoresistive head 1 observed in the step 5 is different from that observed in the step S1, the magnetized head 1, whose magnetized state is different from the normal state or the state previously observed, is evaluated as a product having bad characteristics (bad product) and removed (step S6).

Note that, the steps 1-5 may be repeated a plurality of times, and then the step 6 may be performed. In this case, the steps may be repeated with maintaining the test conditions, e.g., temperature of the step S1, external stresses of the step S4. Further, the steps may be repeated with changing the test conditions. By repeating the steps a plurality of times, instability of the magnetoresistive head 1, which is caused when variation of the magnetized state, e.g. shift of magnetic domain walls, turn of magnetization direction, is occurred, can be evaluated.

In the evaluation method in which said steps are repeated a plurality of times, a characteristic of easily changing the shield magnetic domains can be obvious, so that bad products can be effectively selected and removed.

After performing the evaluation step, the magnetized states of the magnetic layers can be set by applying prescribed magnetic fields to the test head 1 (step S7).

Successively, an example of the step of evaluating the magnetoresistive head will be explained. In this example, the shielding layers 13A and 13B are evaluated. The images of the shielding layers 13A and 13B obtained by the Kerr effect unit 55 are shown in FIGS. 4A and 5A; FIGS. 4B and 5B are schematic view of the shielding layers 13A and 13B based on the obtained images. Note that, arrows in FIGS. 4A-6H indicate magnetization directions of the shielding layers 13A and 13B.

In FIGS. 4A and 4B, the shielding layers 13A and 13B are magnetized in the same magnetization direction without disarraying the magnetization direction. This magnetoresistive head is evaluated as a good product. On the other hand, in FIGS. 5A and 5B, the magnetization direction of the shielding layer 13B is disarrayed, and a magnetic domain wall is formed. The characteristic of this magnetoresistive head is evaluated as a bad characteristic, so this magnetoresistive head is evaluated as a bad product.

Other shielding layers having bad characteristics are shown in FIGS. 6C-6H. Note that, the example shown in FIG. 6A has the normal magnetized state.

In FIG. 6B, the magnetization direction is inverted. In FIGS. 6C-6H, the magnetization directions are disarrayed, and magnetic domain walls are formed. Therefore, they may be evaluated as bad products. Note that, the evaluation may be performed by visual observation of an operator or an automatic image processing unit.

By evaluating other magnetic layers on the basis of evaluation standards, good or bad of the magnetic layers can be evaluated, thereby good products or bad products can be selected.

Conventionally, for example, a magnetoresistive head, which has not been evaluated as a bad product, is attached in a disk drive unit, and then the magnetoresistive head is firstly evaluated as a bad product in a step of evaluating the disk drive unit. On the other hand, in the present invention, the magnetized states of shielding layers and magnetic poles and stability thereof to external stresses, which cannot be evaluated by the conventional methods, can be evaluated. Especially, magnetoresistive heads having unstable shielding layers can be selected. Therefore, attaching bad magnetoresistive heads to disk drive units can be prevented, so that stability and reliability of magnetic drive units can be improved. By performing the observation with the Kerr effect unit after forming sliders in the raw bar, costs for producing singly separated sliders and HGA(Head Gimbal Assembly) assembling can be reduced.

Note that, unlike the conventional method using the Kerr effect, the evaluation method of the present embodiment can effectively compare the magnetized states of the shielding layers and the magnetic poles, to which the external stress or stresses are applied, with those of the shielding layers and the magnetic poles, to which no external stress has been applied. Therefore, the method can effectively evaluate.

In the above described embodiment, the magnetoresistive heads 1 included in the raw bar 10 are evaluated. To reduce production costs and HGA assembling costs, it is suitable to perform the evaluation method of the present invention before or after performing a ρ-H characteristic test, which is performed in the step of processing sliders in the raw bar, but the evaluation method may be performed in any one of production steps between the step of processing the sliders and the step of HGA-assembling as far as the air bearing surfaces can be observed. The evaluation equipment may have a function of the ρ-H characteristic test so as to perform the evaluation test and the ρ-H characteristic test.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of evaluating a magnetoresistive head,
comprising the steps of:
applying a magnetic field to the magnetoresistive head, in the direction parallel to an air bearing surface of the magnetoresistive head, at a prescribed temperature;
obtaining an image of the air bearing surface in a first magnetized state by using the Kerr effect;
applying an external stress to the magnetoresistive head;
obtaining an image of the air bearing surface in a second magnetized state by using the Kerr effect; and
evaluating characteristics of the magnetoresistive head on the basis of the images of the first magnetized state and the second magnetized state or by comparing the image of the second magnetized state with that of the first magnetized state.

2. The method according to claim 1,
wherein the magnetoresistive head includes shielding layers, which are formed on the upper side and the lower side of a magnetoresistance effect reproducing element, and
magnetized states of the shielding layers are evaluated in the evaluating step.

3. A method of evaluating a magnetoresistive head, in which shielding layers are formed on the upper side and the lower side of a magnetoresistance effect reproducing element,
comprising the steps of:
applying a magnetic field to the magnetoresistive head, in the direction parallel to an air bearing surface of the magnetoresistive head;
obtaining an image of the air bearing surface in a first magnetized state by using the Kerr effect;
applying an external stress to the magnetoresistive head;
obtaining an image of the air bearing surface in a second magnetized state by using the Kerr effect;
repeating the above described steps a plurality of times at a prescribed temperature; and
evaluating the magnetized states of the shielding layers by comparing the obtained images of the air bearing surface in the first magnetized states or the obtained images of the air bearing surface in the second magnetized states.

4. A method of evaluating a magnetoresistive head, in which shielding layers are formed on the upper side and the lower side of a magnetoresistance effect reproducing element,
comprising the steps of:
applying a magnetic field to the magnetoresistive head, in the direction parallel to an air bearing surface of the magnetoresistive head;
obtaining an image of the air bearing surface in a first magnetized state by using the Kerr effect;
applying an external stress to the magnetoresistive head;
obtaining an image of the air bearing surface in a second magnetized state by using the Kerr effect;
repeating the above described steps a plurality of times at different temperatures; and
evaluating the magnetized states of the shielding layers by comparing the obtained images of the air bearing surface in the first magnetized states or the obtained images of the air bearing surface in the second magnetized states.

5. The method according to claim 1,
wherein a direction of applying the magnetic field forms an angle with the air bearing surface of the magnetoresistive head in the step of applying the external stress.

6. The method according to claim 3,
wherein a direction of applying the external stress forms an angle with the air bearing surface of the magnetoresistive head in the step of applying the external stress.

7. The method according to claim 4,
wherein a direction of applying the external stress forms an angle with the air bearing surface of the magnetoresistive head in the step of applying the external stress.

8. The method according to claim 1,
wherein an electric current is passed through an element of the magnetoresistive head in the step of applying the external stress.

9. The method according to claim 3,
wherein an electric current is passed through the magnetoresistance effect reproducing element of the magnetoresistive head in the step of applying the external stress.

10. The method according to claim 4,
wherein an electric current is passed through the magnetoresistance effect reproducing element of the magnetoresistive head in the step of applying the external stress.

11. The method according to claim 1,
wherein an electric current is passed through a recording head section of the magnetoresistive head in the step of applying the external stress.

12. The method according to claim 3,
wherein an electric current is passed through a recording head section of the magnetoresistive head in the step of applying the external stress.

13. The method according to claim 4,
wherein an electric current is passed through a recording head section of the magnetoresistive head in the step of applying the external stress.
